(19) United States
(12) Patent Application Publication
(10) Pub. No.: US 2011/0290130 A1
(43) Pub. Date: Dec. 1, 2011

(54) Lightweight portable intaglio printing press

(76) Inventor: Paul L. Whelan, Plano, TX (US)

(21) Appl. No.: 12/800,950

(22) Filed: May 26, 2010

(51) Int. Cl. B41F 3/36

(52) U.S. Cl. 101/158

(57) ABSTRACT

A lightweight portable intaglio press comprises three assemblies: a print table assembly, a side rail assembly and print head assembly. A work piece is positioned on the upper surface of print table assembly (the platen) and between left and right side mounting rail of the side rail assembly. The print head assembly comprises a frame, a print roller rotationally affixed to the frame, a pair of side rail rollers rotationally affixed on either side of the frame and substantially above and behind the print roller on the frame and a pair of handle levers securely affixed to the frame forward of the print roller. An increase in downward force on the work piece at the print roller is realized and related to the ratio of distance between the pair of side rail rollers and the print roller, to the distance between the print roller and the point on the pair of handle levers where downward force is applied. In operation, an operator exerts a downward force on the handles and moves the print head assembly forward and then backward between the left and right side mounting rail and over the work piece.

### CROSS-REFERENCE TO RELATED APPLICATIONS

The present application is related to the following co-pending U.S. patent applications: U.S. patent application entitled, “Portable Intaglio Printing Press”, having application Ser. No. 11/786,292, and filed on Apr. 10, 2007 currently pending. The above identified application is incorporated by reference herein in its entirety.

### BACKGROUND OF THE INVENTION

1. Field of the Invention

The present invention relates generally to printing presses. More particularly, the present invention relates to a method for intaglio print making and an intaglio printing press used therein.

2. Description of Related Art

The term intaglio refers to a die used in printing that is incised so as to produce an image in relief. Generally, an intaglio printing die has incisions, depressions and recessed areas that are marked into a plate of copper, brass, iron, zinc, or even plastic or linoleum. Many different processes and techniques may be employed in making an artwork die from the substrate plate which are suitable for intaglio printing, but a discussion of these techniques is beyond the scope of this application.

The basic methods of intaglio printmaking have remained relatively unchanged for centuries. Once an image has been incised onto a plate, ink is spread on the plate and forces it into the recessed areas of the plate. The surface is wiped clean of ink, leaving only the ink in the recessed areas of the plate. The plate is then placed in a special press and the paper that will receive the intaglio print is registered, face down, on the plate. It should be mentioned that one characteristic of intaglio prints that make them so desirable is the plate mark received in the paper from the outline of the plate, so care is taken that the paper is registered correctly to the plate. Often the paper is dampened to make it receptive to the ink and more supple so that the paper can more easily be pressed into the incised marks (dampening the paper also enhances the print mark). One or more felt blankets are placed over the paper in preparation for the press. The press applies direct pressure to the felt, which compresses the felt, and more importantly, the paper into the inked relief of the image on the plate.

Two general designs of printing presses suitable for intaglio printmaking have been used; a screw-type press that compresses the entire surface of the artwork between two flat plates, and a cylinder-type press that applies rotational pressure on the artwork at a point between two larger cylinders and simultaneously feeds the artwork plate, paper and felt in the direction of rotation. The screw-type press design has been in continuous use since the fifteenth century. It is simple to operate, relatively easy to maintain and has relatively few wear parts to replace. One major drawback in the screw-type design is that because force is simultaneously applied over the entire surface area of the work surface, the working pressure is inversely proportional to the surface area of the work piece. The larger the work surface, the lower the amount of pressure that can be generated from the force applied by the screw. As a practical matter, the performance of most screw-type designs drops off considerably over a few hundred square inches of surface area.

Cylinder-type intaglio printing presses do not suffer from this shortcoming because the pressure to the work piece is applied along a line between two cylindrically shaped rollers. Essentially, the cylinder-type design applies pressure in only one direction along the work surface, rather than across the entire two-dimensional surface area of the work surface as in the screw-type device. Because the surface area between the contact points on the rollers is relatively small, the cylinder-type design enables the operator to focus a significant amount of surface pressure with a comparatively low force applied on the rollers. Therefore, the length of the roller can be increased to accommodate larger artwork without a substantial corresponding decrease in the working pressure common to the screw-type press design.

### BRIEF SUMMARY OF THE INVENTION

The present invention is directed to a lightweight portable intaglio printing press for imprinting a relief image onto paper. The presently described lightweight portable intaglio press comprises three assemblies: a print table assembly, a side rail assembly and print head assembly. A work piece is positioned on the upper surface of print table assembly (the platen) and between the left and right side mounting rail of the side rail assembly. The print head assembly is positioned above the work piece and platen and substantially between and under the side mounting rails. The present print head assembly substantially increases the downward force exerted at the print roller from the force exerted on the lever handles and hence applied to the work piece.

The present print head assembly comprises a frame, a print roller rotationally affixed to the frame, a pair of side rail rollers rotationally affixed on either side of the frame and substantially above and behind the print roller on the frame and a pair of handle levers securely affixed to the frame forward of the print roller. The increase in downward force on the work piece at the print roller is related to the ratio of distance between the pair of side rail rollers and the print roller, to the distance between the print roller and the point on the pair of handle levers where downward force is applied. In operation, an operator exerts a downward force on the handles and moves the print head assembly forward and then backward between the left and right side mounting rail and over the work piece

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1A is a diagram of a cylinder press suitable for intaglio printmaking as is known in the prior art that utilizes a movable bed;

FIG. 1B is a diagram of a cylinder press suitable for intaglio printmaking as is known in the prior art that utilizes a stationary bed and a movable trolley;

FIG. 1C is an upper isometric view of press bed assembly of a printing press suitable for intaglio printmaking in accordance with the prior art;

FIG. 2A is an isometric view of the presently described lightweight portable intaglio press in accordance with one exemplary embodiment of the present invention;

FIG. 2B is a diagram of a side view of the present press in accordance with another exemplary embodiment of the present invention;

FIG. 2C is a front view of the present lightweight portable intaglio press (from the operator's perspective) in accordance with still another exemplary embodiment of the present invention;

FIGS. 2D and 2E are also side and front views of the press, however as opposed to FIGS. 2B and 2C which depict the print head assembly in the working position, the latter two figures depict the print head in the rest position in accordance with additional exemplary embodiments of the present invention;

FIG. 3 depicts an exploded isometric view of the presently described lightweight portable intaglio press in accordance with an exemplary embodiment of the present invention;

FIGS. 4A, 4B, 4C and 4D are side views of the press showing the position of the print head assembly during operation in accordance with one exemplary embodiment of the present invention; and

FIG. 5 is a force diagram showing the force-multiplier affect of the presently described print head assembly in accordance with still another exemplary embodiment of the present invention.

Other features of the present invention will be apparent from the accompanying drawings and from the following detailed description.

DETAILED DESCRIPTION OF THE INVENTION
Element Reference Number Designations

| | | | |
|---|---|---|---|
| 1: | Moveable Bed Cylinder- | 152: | Wing |
| | Type Press | 154: | Wing Guide |
| 2: | Stationary Bed Cylinder- | 156: | Wing Brace |
| | Type Press | 160: | Work Piece |
| 3: | Portable Intaglio Press | 162: | Platen |
| 10: | Upper Roller | 164: | Artwork |
| 12: | Pressure Device | 166: | Transfer Paper |
| 14: | Drive Mechanism | 168: | Absorption Paper |
| 20: | Lower Roller | 170: | Felt |
| 22: | Chain Drive Assembly | 200: | Portable Intaglio Press |
| 30: | Press Bed | 210: | Print Head Assembly |
| 31: | Stationary Press Bed | 211: | Print Head Front Plate |
| 32: | Artwork | 212: | Threaded Opening |
| 34: | Paper | 213: | Handle (Lever) |
| 36: | Felt Layers | 214: | Nut |
| 40: | Trolley | 215: | Knob |
| 102: | Press Bed Assembly | 216: | Print Roller Side |
| 104: | Runway | 218: | Print Roller |
| 110: | Print Head Assembly | 219: | Roller Cam Follower |
| 111: | Magnet | 220: | Roller Spacer |
| 112: | Print Head | 221: | Roller Bearing Nut |
| 113: | Handle (lever) | 222: | Side Rail Cam Follower |
| 114: | Pillow Block Frame | 223: | Side Rail Spacer |
| 115: | Deck | 224: | Nut |
| 116: | Print Roller | 226: | Plate Fastener |
| 117: | Axle | 230: | Print Table Assembly |
| 118: | Bearing | 232: | End Frame |
| 119: | Bearing Axle | 234: | Side Frame |
| 120: | Upper Beam Assembly | 236: | Acrylic Surface |
| 121: | Upper I-Beam Structure | 238: | Plywood Table |
| 122: | Wear Plate | 240: | Table Mounting Screw |
| 124: | Adjustment Slot | 250: | Side Rail Assembly |
| 130: | End Plate | 252: | Side Mounting Rail |
| 132: | Beam Leg | 254: | Front Bracket |
| 134: | Roller Height Gauge | 256: | Rear Bracket |
| 135: | Pointer | 258: | Rest Bracket Fastener Bracket |
| 136: | Table Top Adjustment Lever | 260: | Print Head Assembly Rest |
| 140: | Lower Beam assembly | 262: | Adjustable Lever |
| 141: | Lower I-Beam Structure | 264: | Lever Nut |
| 142: | Table Top Beam | 266: | Elongated Vertical Adjusting |
| 150: | Wing Assembly | | Slot |

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals.

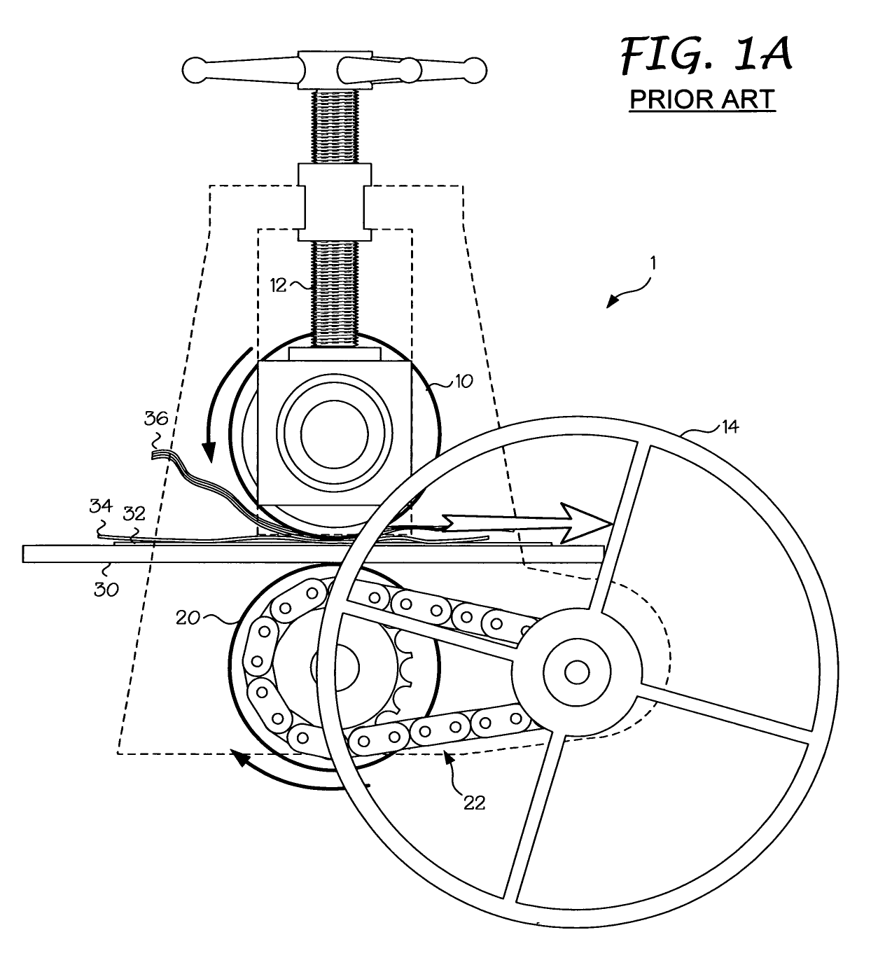

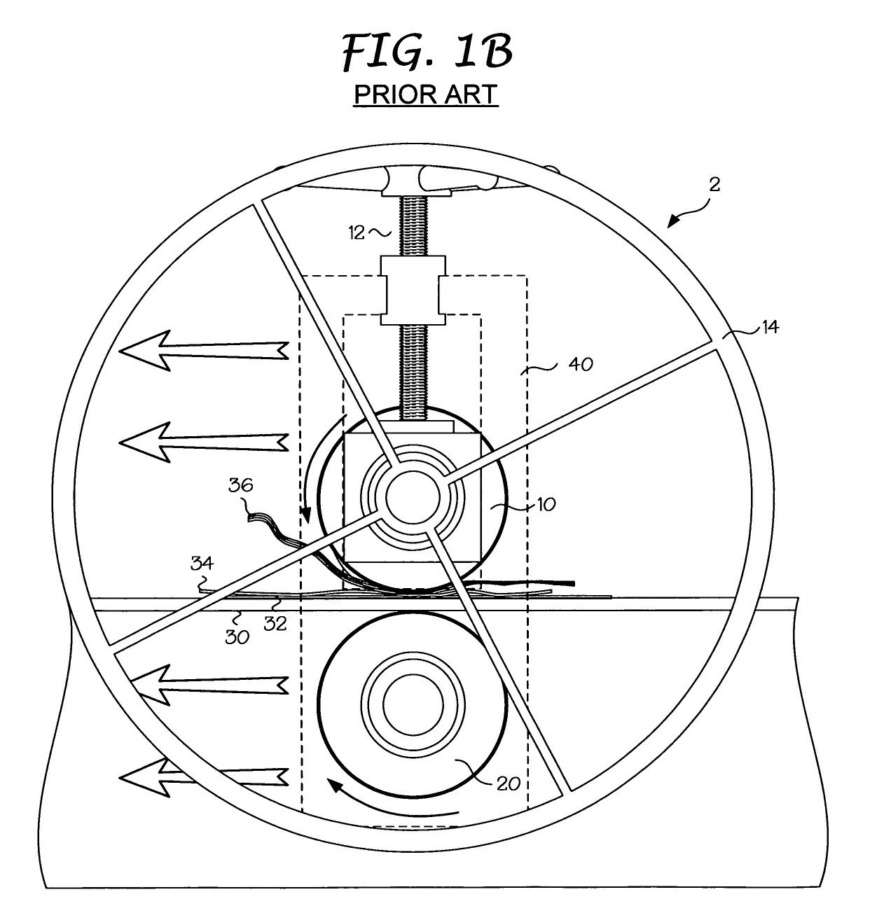

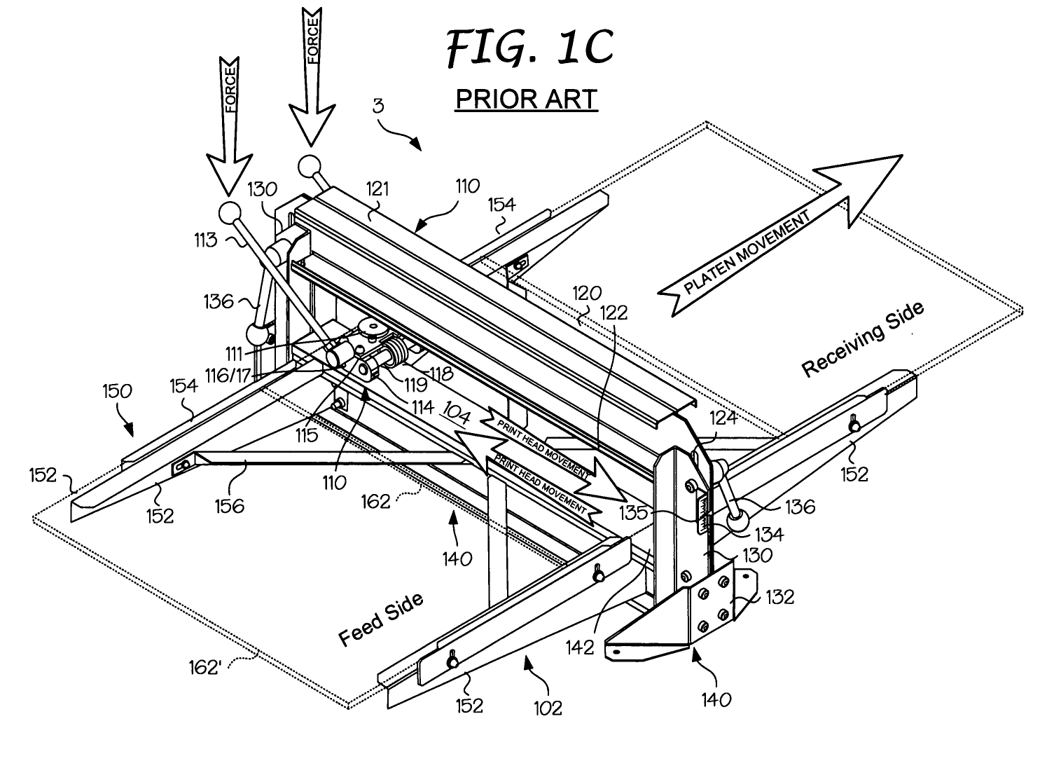

FIGS. 1A and 1B are diagrams of cylinder-type printing presses suitable for intaglio printmaking as is known in the prior art. FIG. 1A depicts a movable bed press and FIG. 1B shows a stationary bed press, such as that disclosed in U.S. Pat. No. 6,216,590 to Whelan entitled “Light Weight Intaglio Printing Press,” which is incorporated by reference herein in their entireties. FIG. 1C shows a stationary bed press, such as that disclosed in U.S. patent application Ser. No. 11/786,292 also to Whelan entitled “Portable Intaglio Printing Press,” which is incorporated by reference herein in its entirety. As presses 1 and 2 depicted in FIGS. 1A and 1B are similar, they will be discussed first. Printing presses 1 and 2 are characterized by two large cylindrically shaped rollers, in which the artwork 32, paper 34 and one or more blankets 36 are pulled through the rollers in the direction of their rotations. In some press designs, e.g., press 1 shown in FIG. 1A, one roller provides the compression force to press paper 34 into artwork 32, i.e., upper roller 10 translates force from pressure device 12 to lower roller 20. In accordance with this particular design, upper roller 10 rotates freely about its axle. The second roller, lower roller 20, provides the rotational force necessary to pull the artwork, paper and felt, between the rollers. In this configuration, the position of upper roller 10 is vertically adjustable to achieve a predetermined pressure, while lower roller 20 is secured in a stationary position in the press frame. A chain and sprocket or gear reduction may be employed to lower the ratio to drive mechanism (hand wheel) 14, thereby reducing the manual force necessary to pull an image (alternatively, a motor may be connected to the sprockets).

Alternatively, and as shown in FIG. 1B, drive mechanism 14 for providing the rotational force may be coupled directly to upper roller 10, thus providing both the pressure and drive force to the same roller. Here, pressure is applied to roller 10 by pressure device 12 and the drive force is applied to the same roller by manually turning hand wheel 14. It is understood that the diameter of the hand wheel should be increased proportional to the gear ratio shown in the preceding diagram in order to realize a corresponding reduction of effort. In this particular design, the work piece remains stationary with regard to the printer bed, while trolley 40 (which includes rollers 10 and 20 and pressure device 12) moves in the direction of the rotation of the rollers and with respect to the stationary bed.

In operation, the operator of an intaglio inks the incised plate and forces the ink into the recessed areas of the plate. Next, the operator wipes the surface of the plate clean of ink and places artwork 32 on press bed 30. Often, bed 30 will be ruled with a square or rectangular grid, to which artwork 32 is registered. A dampened paper is then registered on the grid, face down and over the inked plate. Registering plate 32 and paper 34 to the grid ensures that the plate mark will be transferred into the paper at the proper orientation. One or more felt blankets 36 are placed over paper 34 and fed along table 30 and between upper and lower rollers 10/20. Next, rotational force is applied to the drive roller, with regard to FIG. 1A, lower roller 20. The drive roller rotates in a corresponding direction as the drive force causing artwork 32, paper 34, felt 36 and bed 30 to be pulled across the rollers in a direction perpendicular to the rotational axes of the rollers. The finished print exits the opposite side of presses 1 and 2 and paper 34 is separated from artwork 32 and felt 36. The finished print is then allowed to dry.

Alternatively, and with regard to press 2 depicted in FIG. 1B, upper roller 10 and lower roller 20 may be secured in a movable trolley 40 which rolls across and applies a compressive force to stationary table 31 and the artwork thereon. Stationary bed 31 remains motionless with artwork 32, paper 34 and felt 36 as trolley 40 moves along stationary bed 31 as hand wheel 14 is turned.

The design of the cylinder-type intaglio press enables the operator to concentrate an extremely high pressure between the upper and lower rollers by applying a relatively low force to the upper roller. Furthermore, because the force is evenly distributed along the intersection of the rollers, larger artworks can be accommodated by merely lengthening the rollers. However, longer rollers are more susceptible to flexing under pressure, as a result, the rollers must be strengthened. Prior art press designs rely on a large diameter pressure roller (sometimes eight inches in diameter) to compensate for the pushing action against the plate that causes unwanted roller flexing. The wider the press bed, the bigger the diameter of the roller. Often, these prior art presses weigh over 500 pounds due to the large diameter rollers. Relocating these presses is extremely difficult. Once relocated, the press must be properly leveled and aligned to avoid the bed binding. As might be expected, these large rollers are expensive, cumbersome and difficult to replace.

Generally, prior art roller presses that are suitable for intaglio printmaking comprise two large rollers that pull the artwork between them (either in a movable or stationary bed design). The pressure necessary for creating intaglio print is generated between the rollers by applying a force to one or both of the rollers. The prior art roller presses are further characterized by the manner in which they feed the artwork and paper between the rollers, from one side of the rollers to the opposite side of the rollers based on the direction of rotation. While the roller-type press has many advantages over the screw-type, flat plane press, roller-type presses are heavy and expensive. As longer rollers are needed to accommodate larger prints, the diameter of the rollers must be increased to avoid flexing. What is needed is a lightweight and portable intaglio printing press that is easy to setup, operate and maintain that does not rely on large rollers for printmaking.

Consequently, the lightweight and portable intaglio printing press illustrated in FIG. 1C does not suffer from the shortcomings of the roller-type intaglio printing presses known in the prior art. In accordance with that invention, the operator manually generates the amount of compressive force that is necessary to emboss quality intaglio prints from artwork with a lever, without having to bind the work piece between a pair of rollers and what is a sufficient amount of compressive force for intaglio printmaking. This invention is comprised generally of two assemblies: a press bed assembly and a print head assembly.

With regard to FIG. 1C, an upper isometric view of press portable intaglio press assembly 3 is illustrated. There, intaglio printing press 3 is comprised generally of two assemblies: a press bed assembly (an upper isometric view of press bed assembly 102 and a print head assembly 110. Press bed assembly 102 may be considered as having two distinct functions: it provides structural integrity to support the amount of compressive force necessary for intaglio printmaking; and it also provides a platform for slidably holding the artwork, print and felt. With regard to press bed assembly 102 supporting the forces associated with intaglio printmaking, upper beam assembly 120 is adjustably disposed directly over lower beam assembly 140 and each assembly is attached to end plates 130 at their respective ends. The purpose of this configuration is to provide a horizontal runway (referenced as runway 104) between wear plate 122 on lowermost portion of upper beam assembly 120 and table top beam 142 on the uppermost extent of lower beam assembly 140 for print head assembly 110. In accordance with one exemplary embodiment of the present invention, upper beam assembly 120 comprises upper I-beam structure 121, that has a substantially I-beam cross section, and wear plate 122 that forms or attaches to the lowermost horizontal surface of upper I-beam structure 121. Upper beam assembly 120 extends beyond the I-shaped portion at either end as a substantially planar member that connects to end plates 130. Wear plate 122 should be fabricated from a hard material that creates horizontal raceway for the outside surfaces of bearings 118. Wear plate 122 may be comprised of a ferrous material that will be attracted to a magnetic attachment mechanism on print head assembly 110. Wear plate 122 may provide a completely smooth surface or may instead have a channel or guide surface to contain bearings 118 within the area of wear plate 122 during operation. Lower beam assembly 140 also comprises lower I-beam structure 141, but with table top beam 142 forming or adjoining the uppermost horizontal surface of lower I-beam structure 141. Lower beam assembly 140 may also extend beyond the I-shaped portion at either end as a substantially planar member that fastens to end plates 130. Fastener holes may be disposed along the lowermost horizontal surface of lower I-beam structure 141 for receiving fasteners and securing lower beam assembly 140 directly to a work surface, such as a table or bench. The function of table top beam 142 is to provide a rigid structure beneath platen 162 during operation of print head assembly 110 and that allows platen 162 to be easily slid in a direction perpendicular to the beam assemblies and also perpendicular to the travel direction of print head assembly 110. The function of runway 104 will be described in greater detail below.

The vertical dimension of runway 104 (i.e., the gap formed between wear plate 122 and table top beam 142) is adjustable for accommodating work pieces of varying thicknesses, and for altering the working orientation of a pair of handles on print head assembly 110 (the significance of the orientation will also become more apparent with the descriptions further below). In any case, lower beam assembly 140 is rigidly affixed to end plates 130 at either end of the beam, optimally by removable fasteners for portability. By contrast, upper beam assembly 120 is vertically adjustable and connected to end plates 130 through adjustment slots 124 formed in upper beam assembly 120 at either end (compare, for instance, the vertical position of upper beam assembly 120, with the position of upper beam assembly 120 while in the print position.

The design of this print head assembly serves as a first class lever within a pair of surfaces of a press bed assembly that define runway. The runway structure of the press bed assembly confines a force created by the print head assembly and translates that force into pressure on the print paper covered and inked artwork. The bed assembly has a runway structure defined by upper and lower surfaces that are separated by a predetermined distance and substantially parallel to each other. The print paper and inked artwork are positioned against the lower surface and the print head portion of the print head assembly is situated between the artwork and the upper surface. The print head assembly comprises one or more lever handles positioned on either side of the upper beam assembly. The lever handle(s) serves at least two purposes: to provide a torque lever for receiving a manually exerting downward force and translating that force into compression force on the artwork and print paper; and to provide a handle for moving the print head assembly along the runway and making compression passes across the artwork. The track roller and compression roller are secured a predetermined distance from each other and within a housing that forces the compression roller against the work piece (the print paper and inked artwork) residing on the lower surface of the runway and simultaneously forces the track roller (or bearings) against the upper surface of the runway. Printmaking proceeds one pass at a time across the lateral extent of the print paper covered artwork. Furthermore, rather than drawing the work piece past a pair of rollers using the rotation of the rollers as is typical of prior art presses, the work piece is not pulled into, by or past the rollers. In fact, the movement of the work piece does not correspond to the rotation of the compression roller. In short and in stark contrast with the prior art, the operation of the present invention is not dependent on the interaction between a pair of rollers and the work piece. After each subsequent pass of the print head over the work piece (or any number of passes that the operator deems sufficient to create the desired affect on the print paper), the work piece is moved perpendicularly with respect to the direction of the print head passes, thereby exposing a fresh area of the work piece for imprinting.

The presently described intaglio printing press is lighter and more portable than those known in the prior art, and correspondingly less expensive to fabricate, yet capable of producing intaglio prints that are indistinguishable from those produced by the more expensive presses known in the prior art. At the same time, the intaglio printing press of the present invention is far less complicated to operate than many of the roller-type presses known in the prior art. Furthermore, the present intaglio printing press is relatively easy to maintain having few moving or wear parts to replace. Still further, because the compression roller of the present invention is substantially smaller than those used with previous presses, this roller is much less expensive to replace than those used in the prior art.

However, even though intaglio printing press 3 is much improved over previously known intaglio printing presses, is much lighter and far more portable than those in the prior are, intaglio printing press 3 is still somewhat complicated to use and relatively expensive to manufacture. One advantage of the printer is its ability to process virtually any large format artwork by sliding the platen laterally under the upper beam assembly while moving the print head assembly parallel to the upper beam assembly. However, this capability requires that the upper and lower beam assemblies be fabricated from an extremely rigid material. Furthermore, in order to accommodate large format artwork, the press bed assembly is supported by a pair of support wings and material guides on either side of the upper and lower support assemblies. Hence, while the structure is not overly complicated, it is somewhat expensive to produce. Additionally, operating intaglio printing press 3 requires two distinct and separate manual procedures, running the print head assembly across the artwork, and then repositioning the artwork under the upper support assembly for a subsequent pass of the print head assembly. Because the operator must often repeatedly move from the front side of the press to the feed side of the press, it is sometimes advantageous to utilize two operators. Moreover, the operational complexity of the press is not entirely dependent on the size of the artwork. Because the print head assembly uses a relatively narrow print roller, even small format artwork requires multiple passes with the print head.

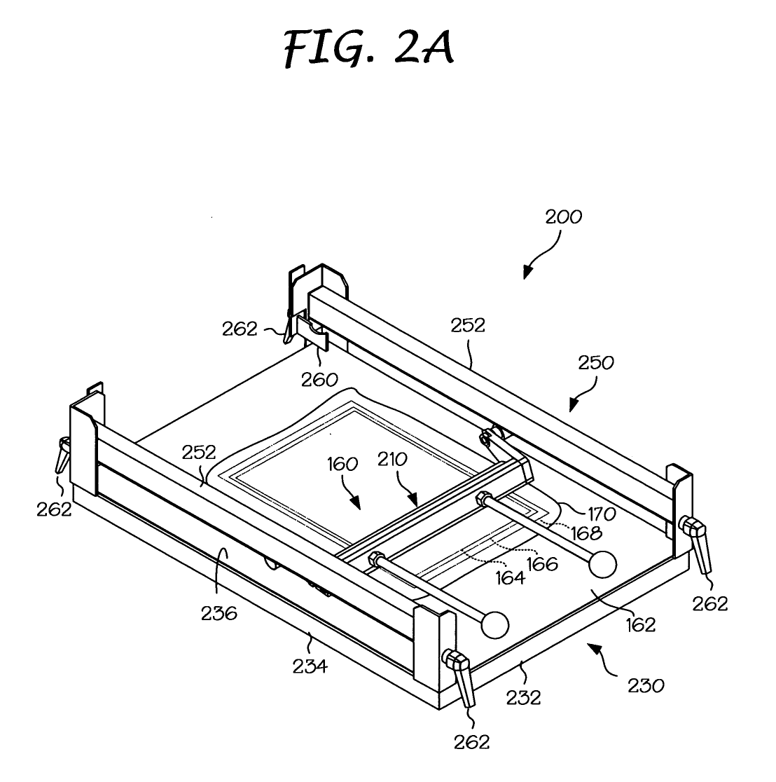

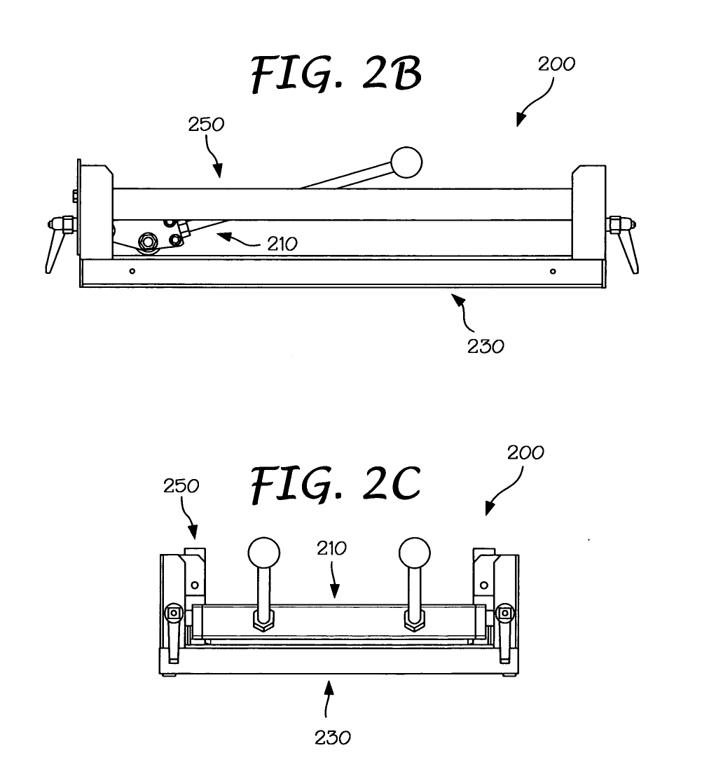

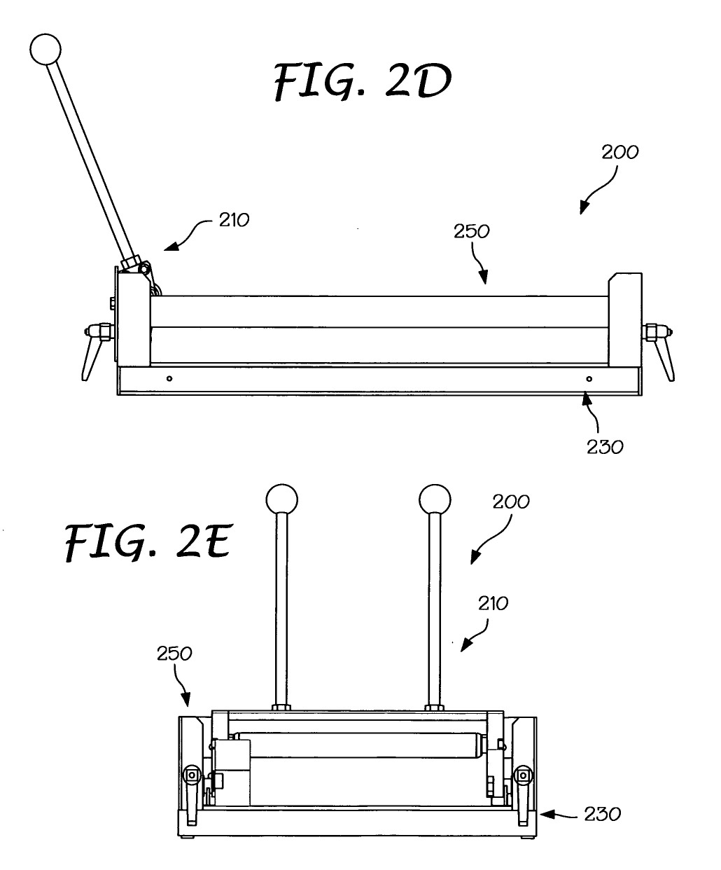

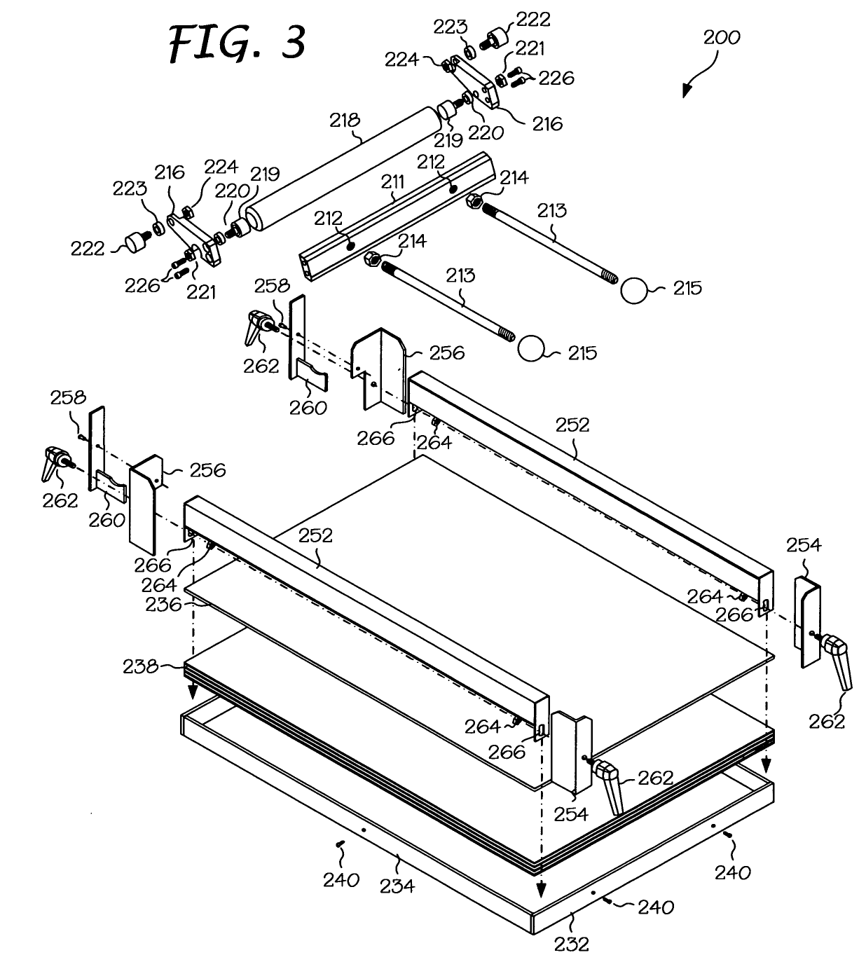

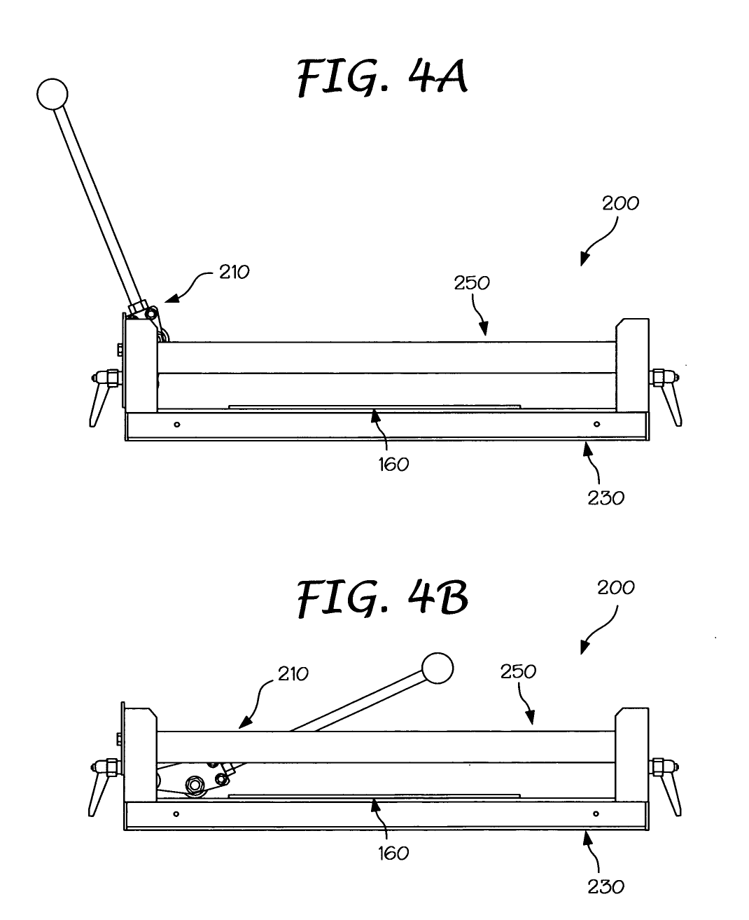

In consideration of the shortcomings of the prior art intaglio presses, a lightweight portable intaglio press is present in accordance with exemplary embodiments of the present invention. The present invention will be described with regard to FIGS. 2-5. FIG. 2A is an isometric view of the presently described lightweight portable intaglio press in accordance with one exemplary embodiment of the present invention. FIG. 2B is a diagram of a side view of the present press in accordance with another exemplary embodiment of the present invention. FIG. 2C is a front view of the present lightweight portable intaglio press (from the operator's perspective) in accordance with still another exemplary embodiment of the present invention. FIGS. 2D and 2E are also side and front views of the press, however as opposed to FIGS. 2B and 2C which depict the print head assembly in the working position, the latter two figures depict the print head in the rest position in accordance with additional exemplary embodiments of the present invention. FIG. 3 depicts an exploded isometric view of the presently described lightweight portable intaglio press in accordance with an exemplary embodiment of the present invention.

Turning now to FIGS. 2A, 2B, 2C, 2D, 2E and 3, it can be appreciated that lightweight portable intaglio press 200 comprises three assemblies: print table assembly 230, side rail assembly 250 and print head assembly 210. Essentially, work piece 160 is positioned on the upper surface of print table assembly 230 (commonly referred to as the platen, platen 162), and between the left and right side mounting rail 252 of side rail assembly 250. Print head assembly 210 is essentially positioned above print table assembly 230, and work piece 160, and between and under side mounting rails 252. The mechanical configuration of lightweight portable intaglio press 200 provides sufficient leverage to create a working force to imprint on a relatively wide work piece, twelve inches and greater, without having to reposition the work piece. The impressioning forces created using portable intaglio press 3 are substantial, however, the print roller surface is relatively narrow, requiring multiple passes between repositioning the work piece.

One aspect of the present invention that facilitates this goal is that print roller 218 is positioned between left and right side mounting rails 252, rather than under the upper I-beam structure as in portable intaglio press 3. One advantage of this configuration is that the maximum width of the roller is restricted by the distance between left and right side mounting rails 252 and not the width of the upper I-beam structure, hence print roller may be much wider than in the prior art. Also, in operation the operator maneuvers print roller assembly 210 between left and right side mounting rails 252 and not around the upper beam assembly. In so doing, the operator has a clear, unobstructed line of sight view of work piece 160, in contrast with the prior art in which the operator must peer around the upper beam assembly to view the print roller. The configuration of the present lightweight portable intaglio press 200 also reduces the likelihood that the operator's head will come in contact with any portion of the press. Finally, by replacing the single print head bearing (for applying pressure to the underside of the upper I-beam structure) with a pair of cam followers, one disposed at either end of the print roller, control over the movement and direction of print head assembly 210 is dramatically increased over the prior art print head assembly. Additionally, depending on spacing of the left and right side mounting rails 252, it may also be possible to increase the spacing between left and right lever handles 213 which further increases the operational stability and control that the operator has over the movement and direction of print head assembly 210.

With further regard to the structure of the presently described lightweight portable intaglio press 200, print table assembly 230 provides a rigid structure for supporting work piece 160 and also base for anchoring side rail assembly 250. In accordance with one exemplary embodiment of the present invention, print table assembly 230 comprises plywood table 238 which acts as a substrate for acrylic surface 236. Typically, plywood table 238 will be a multi-layered dense hardwood construction such as a cabinet grade of plywood (preferably at least 0.75 inch thick) and acrylic surface 236, which is a strong, but slightly flexible acrylic (preferably at least 0.125 inch thick), such as a melamine resin or the like which is extremely well known in the cabinetry arts. Surrounding plywood table 238 is a substantial metal frame, with an opposing pair of end frames 232 and an opposing pair of side frames 234. In general, the side dimensions are longer than the end dimensions of the table. The pair of end frames 232 is secured between the pair of side frames 234 with rigid fasteners or by welding the frames ends together. Holes are provided for inserting table mounting screws 240. Nonskid strips may be secured to the underside of the table and/or frame as desired.

Side rail assembly 250 comprises left and right side mounting rails 252 that are oriented substantially parallel to each other and positioned above the sides of print table assembly 230 and are secured to or at the corners of the metal frame of print table assembly 230. Each side mounting rail 252 comprises a sturdy rectangular tube of metal stock, preferably steel, with a smooth side for engaging side rail cam follower 222. Side mounting rail 252 should be at least as wide as side rail cam follower 222, 0.75 inches or wider, and high enough to prevent bowing when pressure is applied, at least 1.50 inch, with a thickness of at least 0.125 inches. Alternatively, the rectangular tube may be fabricated from two identical pieces of angle iron, for instance side mounting rails 252 having dimensions of 1.0 in.×2.0 in.×0.25 in.×2.0 ft. may be fabricated from a pair of 2.0 foot pieces of 1.0 in.×2.0 in×0.25 in. welded together. Still again, side mounting rails 252 may be comprised of metal having a square, channel or even angle cross sectional shape, rather than rectangular, so long as the downward facing surface is sufficiently smooth and wide to accommodate side rail cam follower 222 and the rail is sufficiently rigid not to bow excessively with pressure.

Side rail assembly 250 further comprise front bracket 254 at the front end of the table, and rear bracket 256 at the rear end of the table, with side mounting rail 252 secured therebetween. Front bracket 254 and rear bracket 256 are preferably joined to frame corners formed by end frames 232 and side frames 234 using substantial fasteners or by a weld (neither shown). Optionally, an end flange extends below each end of side mounting rail 252 for securing the ends of side mounting rail 252 to an inner surface of each front bracket 254 and rear bracket 256. Optimally, side mounting rail 252 is moveably secured between front bracket 254 and rear bracket 256 for providing elevation (height) adjustments to side mounting rail 252. One exemplary adjustment mechanism for side rail assembly 250 is to provide a vertical slot in either the lower end flange of side mounting rail 252 or front bracket 254 and rear bracket 256, through which a fastener adjustably couples the ends of side mounting rail 252 to each of front bracket 254 and rear bracket 256. The exemplary press depicted in the figure shows elongated vertical adjusting slot 266 disposed on either end flange below each end of side mounting rail 252, with a corresponding round hole in the front bracket 254 and in rear bracket 256. In this configuration, a threaded fastened from adjustment handle 262 traverses the round hole in front bracket 254 or rear bracket 256 and the elongated vertical adjusting slot 266. The elevation of side mounting rail 252 is fixed by nut 264, by tightening the threaded fastener into nut 264 with adjustment handle 262 and is secured. Here, the elevation of adjustment handle 262 remains constant regardless of the elevation adjustment on side mounting rail 252. Alternatively, elongated vertical adjusting slot 266 could be disposed on front bracket 254 and rear bracket 256, with the round hole disposed in the end flanges of each side mounting rail 252. In that configuration, nut 264 could be secured to the backside of the flanges side mounting rail 252 (using, for example a PEM® nut). In this configuration, the elevation of adjustment handle 262 would change corresponding to the elevation of side mounting rail 252. As will be discussed further below, in operation the operator stands as the front end of print table assembly 230 thereby moving print head assembly 210 across work piece 160 positioned between left and right side mounting rail 252. Between each impression, felt 170, absorption paper 168, transfer paper 166 and possibly artwork 164 must be removed and replaced from platen 162. Therefore, print head assembly 210 should be removed from the surface of the table. To that end, print head assembly rests 260 are secured at each of rear brackets 256 that each have a rest member with a concave shaped edge for accepting roller spacer 220 on roller cam follower 219. In so doing, print head assembly 210 is elevated above the surface of the table and handle levers 213 are rotated up and toward the back side of the table as shown in FIGS. 2D and 2E. Work piece 160 can then be removed, replaced or repositioned as necessary without interference from print head assembly 210.

Print head assembly 210 is designed to multiply the downward force exerted on lever handles 213 (or knobs 215) into a substantially greater force at print roller 218 on work piece 160. Print roller 218 is a hard, usually metallic cylindrically shaped device that is free to rotate about its longitudinal axis and suspended between a pair of print roller sides 216. Print roller sides 216 have several orifices for receiving fasteners and the like. For instance, print roller 218 revolves about, for example, an axle on bearings received within the cylindrical structure of print roller 218. Either end of the axle is fastened to, or through opposite print roller sides 216, through a spacer to prevent print roller 218 from binding on print roller sides 216. Alternatively, and as depicted in the figure, print roller 218 revolves about a pair of cam followers 219, received in cylindrically shaped chambers on either side of the cylindrical structure of print roller 218. As is well understood in the art, a cam follower (or track follower) is a roller or needle bearing with an outer surface designed to follow cam surfaces and the like. The cam follower discussed herein as the “stud-type” of cam follower in which the bearing and outer surface is free to rotate around the axle. The studs of cam followers 219 are secured on print roller side 216 facing inward, via roller bearing nut 221, with roller spacer 220 disposed on the stud between the roller surface and print roller side 216. The mounting holes on print roller side 216 for cam followers 219 are positioned near to lower surface of the print roller side, such that print roller sides 216 do not contact table acrylic 236 during working, and such that print roller 218 easily contacts work piece 160. For achieving maximum force on the work piece, mounting holes for cam followers 219 are forward of a midpoint line on print roller side 216, perhaps half the distance from the midpoint line of print roller side 216 and the front end of print roller side 216.

A second set of stud-type cam followers is secured to print roller sides 216, one on either side of the print roller and facing outward, for engaging or “tracking” the underside surface of side mounting rail 252. Exemplary side rail cam followers 222 are secured on the outward side of print roller sides 216, using nut 224, with roller spacer 220 disposed on the stud between the cam follower bearing and print roller side 216. Side rail cam followers 222 are positioned near the rear of print roller sides 216. Print roller sides 216 are secured into a rigid structure around print roller 218 with print head front plate 211, which is secured between both print roller sides 216 using plate fasteners 226. Print head front plate 211 is posited at the front-most extent of print roller sides 216, proximate to print roller 218, without interfering with its rotation. A pair of threaded openings 212 is formed in print head front plate 211 for receiving threaded end of handle levers 213 (a locking nut 214 is provided to prevent handle levers 213 from working loose). Pliable knobs 215 are fitted on the distal ends of handle levers 213.

Alternatively, to using a pair of side rail cam followers, single side rail roller may be substituted that extends between the underside surfaces of both side mounting rails 252. In that case, print roller sides 216 may extend beyond the lateral extent of left and right side mounting rail 252.

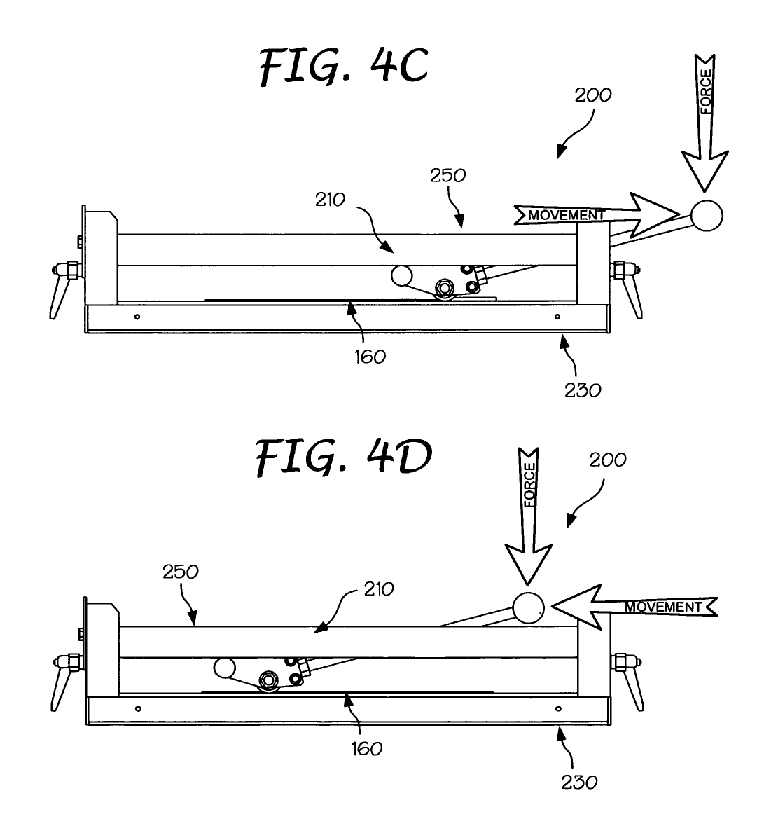

FIGS. 4A, 4B, 4C and 4D are side views of the press showing the position of the print head assembly during operation in accordance with one exemplary embodiment of the present invention. Initially, as depicted in FIG. 4A, print roller assembly 210 is positioned in the rest position on print head assembly rests 260 and away from platen 162. Consequently, work piece 160 can be adjusted, maneuvered, inked or replaced without print roller assembly 210 obstructing the procedure. Next, as depicted in FIG. 4B, print roller assembly 210 is lowered to the table with print roller 218 resting on print table surface 236. At this point, the operator has not yet begun to exert pressure on handle levers 213. In FIG. 4C, the operator has begun the process of imprinting work piece 160. Operationally, the operator performs two tasks, she exerts a downward pressure on handle levers 213 and simultaneously exerts a front or rear movement on handle levers 213, beginning with a rear movement for pulling print roller assembly 210 toward the front end of lightweight portable intaglio press 200 (toward the operator). As print roller 218 contacts work piece 160 (transfer paper 166 and inked artwork 164), ink is impressed into print 164. The operator should take care to pull print roller assembly 210 toward the front end of lightweight portable intaglio press 200 in a straight line, in order to avoid side rail cam followers 222 from disengaging side mounting rail 252 and/or print roller sides 216 binding with the mounting rails. Once print roller assembly 210 has traversed the full extent of work piece 160 on platen 162, the operator reverses course and pushes print roller assembly 210 toward the rear end of lightweight portable intaglio press 200 (away from the operator). Here again, care should be taken to keep side rail cam followers 222 aligned with the underside surface of side mounting rail 252.

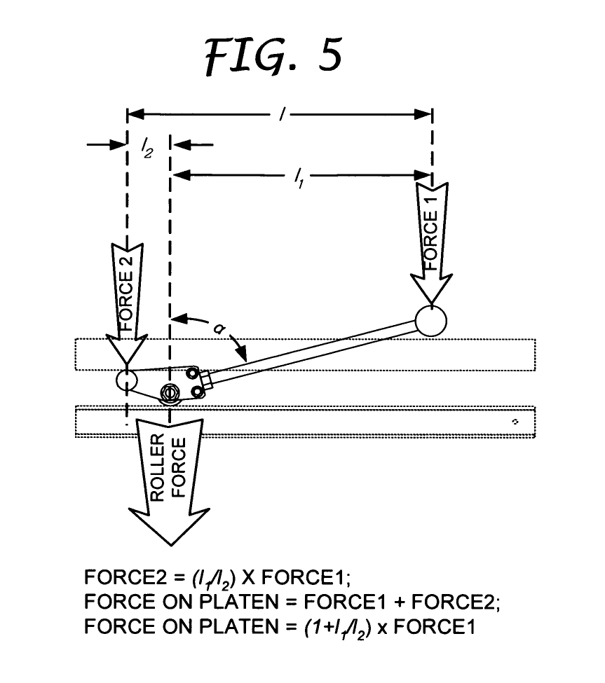

FIG. 5 is a diagram that demonstrates the mechanics of the first class lever structure of the print head assembly 210 in accordance with an exemplary embodiment of the present invention. In order to calculate the force exerted on work piece 160, the magnitude of forces in the downward direction must be found, these are the manual forces exerted by the operator and the force exerted by the upper support beam on the track roller. The force at the track roller can be found from torque arm calculations. The operator applies a downward force (FORCE1) at the distal end of lever handles 213, which is a horizontal distance of l₁ from the fulcrum (print roller 218 through cam followers 219). Since print head assembly 210 is in static equilibrium, a resistance torque of FORCE2×l₂ is created at side rail cam followers 222 because side rail cam followers 222 is a distance of l₂ from the fulcrum (print roller 218). Thus, the force that results at side rail cam followers 222 is proportional to the force exerted at the handles, i.e.,

$$FORCE 2 = ( 1 + \frac{{l}_{1}}{{l}_{2}} ) \times FORCE 1.$$

By summing the downward forces, the Print Roller Force=FORCE1+FORCE2 or

$$( 1 + \frac{{l}_{1}}{{l}_{2}} )$$

Manual Force exerted by the operator on handles 213. Assuming a 10:1 mechanical advantage, then the downward force exerted on the platen by print roller 218 will be approximately 11× the magnitude of the downward force manually exerted on the distal ends of lever handles 213. It should also be mentioned that the length of the torque distance for these calculations is a function of its orientation to the horizontal plane (angle α) in which it is operating (e.g., l₁=(length of handle 213×cos(α))). Optimally, angle α should be as large as possible without the operator contacting the platen or work piece, greater than seventy degrees is optimal.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

1. A printing press comprising:
a press table assembly, comprising:
a platen, said platen having an upper surface for supporting a work piece:
a side rail assembly, comprising:
a first side rail having a first side rail lower surface;
a second side rail having a second side rail lower surface, said second side rail substantially parallel to said first side rail; and
a plurality of brackets mechanically coupled to the press table assembly for supporting the first and second lower side rail surfaces of the respective first and second side rails above the upper surface of the platen;
a print head assembly, comprising:
a print head frame;
a print roller, said print roller rotationally secured by the print head frame;
a first side rail roller, said first side rail roller rotationally secured by the print head frame and adapted for contacting and rotationally tracking with the first side rail lower surface of the first side rail; and
a second side rail roller, said second side rail roller rotationally secured by the print head frame and adapted for contacting and rotationally tracking with the second side rail lower surface of the second side rail;
a handle arm secured to the print head frame.

2. The printing press device recited in claim 1, wherein the press table assembly further comprises:
a table frame mechanically coupled to the platen and further coupled to at least one of plurality of brackets.

3. The printing press device recited in claim 1, wherein the combination of the print roller, the first and second side rail rollers and handle arm are adapted for exerting a first force on the first and second side rail lower surfaces of the respective first and second side rails and a second force on the upper surface of the platen.

4. The printing press device recited in claim 2, wherein the first side rail is separated from the second side rail by a lateral distance, said lateral distance being greater than a width of a work piece.

5. The printing press device recited in claim 4, wherein the print roller comprises a longitudinal length, longitudinal length being less than the lateral distance between the first and second side rails.

6. The printing press device recited in claim 2, wherein the plurality of brackets further comprises:
a first pair of brackets for supporting the first lower side rail surface of the first side rail above the upper surface of the platen; and
a second pair of brackets for supporting the second lower side rail surface of the second side rail above the upper surface of the platen.

7. The printing press device recited in claim 1, wherein at least one of the print head assembly, side rail assembly and the press table assembly further comprises:
an elevating rest mechanism for resting the print head assembly above the upper surface of the press table assembly.

8. The printing press device recited in claim 6, wherein the first pair of brackets for supporting the first lower side rail surface of the first side rail above the upper surface of the platen is mechanically coupled to the press table assembly.

9. The printing press device recited in claim 8, wherein the second pair of brackets for supporting the second lower side rail surface of the second side rail above the upper surface of the platen is mechanically coupled to the press table assembly.

10. The printing press device recited in claim 6, wherein one bracket of the first pair of brackets and the first side rail is adjustable for altering a distance between the first side rail lower surface of the first side rail and the upper surface of the platen, and one of the second pair of brackets and the second side rail is adjustable for altering a distance between the second side rail lower surface of the second side rail and the upper surface of the platen.

11. The printing press device recited in claim 2, wherein the first and second side rails are adjustable for altering a vertical distance between the first and second side rail lower surfaces of the respective first and second side rails and the upper surface of the platen.

12. The printing press device recited in claim 11, wherein the first and second side rail lower surfaces of the respective first and second side rails lie in a horizontal plane.

13. The printing press device recited in claim 10, wherein the press table assembly further comprises:
an adjustment mechanism for adjustably coupling the first side rail to the first pair of brackets and for adjustably coupling the second side rail to the second pair of brackets.

14. The printing press device recited in claim 12, wherein the print roller of print head assembly being disposed substantially perpendicular to and between the first side rail lower surface of the second side rail lower surface.

15. The printing press device recited in claim 12, wherein the print roller of print head assembly being disposed substantially perpendicular to and between the first side rail and the second side rail.

16. The printing press device recited in claim 2, wherein the print head assembly further comprises:
a second handle arm secured to the print head frame a distance from the second side rail roller equivalent to the distance between the first side rail roller and the first handle arm.

17. The printing press device recited in claim 16, wherein in operation, the handle arm and second handle arm are oriented within twenty degrees of horizontal.

18. The printing press device recited in claim 17, wherein an angle between a plane defined by the handle arm and second handle arm and a second plane is defined by the axis of the print roller and the first and second side rail rollers is determined by the orientation of the handle arm and second handle arm.

19. The printing press device recited in claim 1, wherein a longitudinal axis of the print roller is substantially parallel to the upper support surface of the lower support assembly.

20. The printing press device recited in claim 1, wherein at least a portion of the first side rail roller extends above the print roller and at least a portion of the second side rail roller extends above the print roller.
